(19) United States
(12) Patent Application Publication
(10) Pub. No.: US 2012/0232931 A1
(43) Pub. Date: Sep. 13, 2012

(54) PATIENT MONITORING SYSTEM

(75) Inventors: Harm Jacob Buisman, Eindhoven (NL); Aleksandra Tesanovic, Eindhoven (NL); Rob Theodorus Udink, Lieshout (NL)

(73) Assignee: KONINKLIJKE PHILIPS ELECTRONICS N.V., EINDHOVEN (NL)

(21) Appl. No.: 13/509,312

(22) PCT Filed: Oct. 15, 2010
(86) PCT No.: PCT/IB10/54686

§ 371 Date: May 11, 2012

Related U.S. Application Data
(60) Provisional application No. 61/261,436, filed on Nov. 16, 2009.

(51) Int. Cl. G06Q 50/24

(52) U.S. Cl. 705/3

(57) ABSTRACT

A patient monitoring system for determining a health coaching parameter of a patient, the patient monitoring system comprising: A. a health professional user interface; B. a patient user interface; C. a patient database comprising an electronic health record belonging to the patient; D. a domain model comprising a knowledge base for a medical condition; E. a template database comprising at least one template form for constructing at least one question and possible responses to the at least one question about the medical condition using the domain model, wherein the at least one template form comprises a mapping for each of the possible responses to determine a value for the health coaching parameter; F. a computing device comprising: at least one processor, memory, and one or more programs; wherein the one or more programs are stored in memory and configured to be executed by the one or more processors; wherein the one or more programs comprise instructions for: receiving a request for a health coaching parameter from the health professional user interface; retrieving the knowledge base for the medical condition; constructing the at least one question and the possible responses using the knowledge base and the at least one template form; receiving a response from the patient user interface; determining the value for the health coaching parameter using the response and the mapping; recording the value of the health coaching parameter in the electronic health record; selecting a subset of the knowledge using the response; and providing the patient with the subset of the knowledge base using the patient user interface.

This patent application claims the priority benefit under 35 U.S.C. §119(e) of U.S. Provisional Application No. 61/261,436 filed on Nov. 16, 2009, the contents of which are herein incorporated by reference.

The invention relates to patient monitoring systems, in particular a patient monitoring system for determining a health coaching parameter.

The goal of the disease management programs, including remote patient management systems, and lifestyle/behavior change programs such as weight management, smoking cessation, or activity programs is to empower patients to control their complex chronic condition. The key component of these programs is therefore coaching the patient. Coaching addresses the following:
Improving knowledge about the chronic condition or specific aspects of these;
Changing attitudes of the patients toward certain behaviors that they need to adopt in order to adhere to the prescribed medication and lifestyle goals;
Moving a patient through stages of change, e.g., from pre-contemplation, through contemplation, action and maintenance; and
Removing perceived barriers and enforcing the benefits that a patient has toward the specific behavior or a goal.

When it comes to types of disease management, there are generally two ways of communication: traditional face to face counseling and counseling using remote patient monitoring systems.

Face to face counseling implies a meeting with the specialized nurse who interviews the patient, based on her experience assesses the current level with respect to knowledge, attitudes and state of change, and then provides, based on their experience, feedback in terms of counseling and/or suggests an appropriate education material. This process is often time-consuming, costly, and greatly dependent on the nurses' experiences to ask appropriate questions that would lead to extracting the coaching parameters relevant to a particular chronic condition and provide an appropriate feedback. In addition, the nurse is never sure about the impact of her advice as he or she does not have the means to measure it.

Counseling using remote patient monitoring systems relies on the results of questionnaires, which are normally built by a clinical application expert to address a specific topic of a certain disease for the entire patient population (e.g., knowledge on importance of measurements in diabetes management). These questionnaires are therefore too generic (for entire patient population) and do not provide quantitative information to the professional that would enable them to (i) determine the best intervention for that particular patient as well as (ii) the effect of their intervention; an intervention for example could be coaching sessions via face to face meeting, delivery of educational material via face to face meetings or via a remote patient monitoring system.

Hence, the problem that health professionals encounter in disease management addressed by this invention is a lack of quantitative assessment of patient health behavioral status that prevents them to:
Measure the effect of their coaching intervention on a patient (in terms of his knowledge, current motivational state, barriers and benefits, etc.).
Choose coaching intervention for a particular patient. For instance, does he or she need knowledge or motivation or move to a particular state of change?
Increase the effect of their intervention.

Embodiments of the invention address these and other problems by providing a health professional with a way to assess a health coaching parameter, and improve the effect of interventions. Embodiments of the invention may be relevant to both remote patient monitoring systems and also to other health coaching situations, like a face to face consultation.

In an aspect of the invention, the invention provides for a patient monitoring system for determining a health coaching parameter of a patient. The patient monitoring system as used herein is defined as an electronic system adapted for monitoring the well being and/or health status of a patient. The patient monitoring system may be a monitoring system in use by a physician with the patient. The patient monitoring system may also be a remote patient monitoring system. A remote patient monitoring system is a patient monitoring system which reports a patient's health status, well being, and/or values of patient vital signs to a remote server or health professional at a location that is remote to the patient. For instance, a remote patient monitoring system could be connected by telephone line or computer network connection such as the internet. This allows physicians to remotely monitor the status of the patient.

The patient monitoring system comprises a health professional user interface. The health professional user interface is an interface which a health professional such as a doctor, nurse, or other caregiver can use to monitor the progress or status a patient. The health professional user interface may also be used to direct the patient's therapy remotely. The patient monitoring system further comprises a patient user interface. The patient user interface is an interface which allows a patient to input information to the patient monitoring system. The patient user interface may also be adapted for displaying information from the patient monitoring system. For instance, the patient user interface may display questions and it may also display information for training the patient.

The patient monitoring system further comprises a patient database comprising an electronic health record belonging to the patient. The electronic health record may be a database or system which stores patient records remotely or locally. A patient record is used herein as a record which contains information about a particular patient and also that particular patient's health record. The patient monitoring system further comprises a domain model comprising a knowledge base for a medical condition. The domain model contains a knowledge base of information which is descriptive of the medical condition. The domain model may contain text information, detailed medical information, multimedia information, and also pointers or links to other sources of information about the medical condition.

The patient monitoring system further comprises a template database comprising at least one template form for constructing at least one question and possible responses to the at least one question about the medical condition using the domain model. A template form used herein is a document or an electronic record which contains templates for constructing questions and possible responses or answers to those questions. The at least one template form comprises a mapping for each of the possible responses to determine a value for the health coaching parameter.

A health coaching parameter as used herein is a parameter which ranks a patient's knowledge or attitude towards a parameter which affects the progress or success of a therapy treatment. For instance the health coaching parameter could be a rating of a patient's knowledge about a medical condition. The health coaching parameter could also be a measure of the patient's knowledge of how to properly treat or deal with a particular medical condition. The health coaching parameter could also be a measure of the motivation of the patient towards therapy. Determining the value of a health coaching parameter is beneficial because this allows a physician or other care giver to decide when a personal intervention or training for the patient is necessary. A value for the health coaching parameter could be described in several ways. For instance a numerical value could be used as a health coaching parameter. The value for the health coaching parameter could also have discreet levels. Instead of a numerical value, a label which describes the value of the health coaching parameter could be used. The mapping for each of the possible responses could be a numerical formula which is used to assign a value, or there could be mapping such that if a particular question is answered correctly or incorrectly by the patient results in a value for the health coaching parameter being assigned. The patient could also have a current or an initial value for the health coaching parameter. Answering questions could raise or lower the value or change the ranking if numerical values are not used.

The patient monitoring system further comprises a computing device comprising at least one processor, memory, and one or more programs. A computing device is defined herein as any machine designed for executing a program. Examples of computing devices are, but are not limited to: a computer, a computer system, a network of computers, a cellular telephone, a personal digital assistant and an automobile. The one or more programs are stored in memory and configured to be executed by the one or more processors. The one or more programs comprise instructions for receiving a request for a health coaching parameter from the health professional user interface. For example a health professional such as a physician could review the patient record and request the value of a health coaching parameter which would allow the physician to make an informed decision for adjusting a patient's therapy. The one or more programs further comprise instructions for retrieving the knowledge base for the medical condition.

The one or more programs further comprise instructions for constructing the at least one question and the possible responses using the knowledge base and the at least one template. Information from the knowledge base is used to fill blanks in the template to construct the at least one question.

The one or more programs further comprise instructions for receiving a response from the user interface. In this step the patient had answered the at least one question. After the at least one question was constructed the at least one question may have been displayed or presented to the patient. The method of displaying or presenting the question to the patient depends upon the media or type of template form that was used. For instance the question could have been posed using a recording or a speech synthesizer. Textual questions may be displayed on a screen or monitor. Animations, avatars or multimedia clips may also be displayed on a display or monitor. The response from the patient user interface could also be in a variety of methods. For instance a keyboard could be used to enter a response, a touch sensitive screen could be used to enter a response, or a voice recognition system may be used to respond to an oral response by the patient.

The one or more programs further comprise instructions for determining the value for the health coaching parameter using the response and the mapping. The response was received from the patient via the patient user interface and then the mapping and the response is used to determine the value for the health coaching parameter. A variety of different mappings could exist. A formula could be used for calculating the value of a health coaching parameter, a response to a particular question could result in a particular value being assigned to the health coaching parameter, or a correct or incorrect answer could modify an existing value of a health coaching parameter.

The one or more programs further comprise instructions for recording the value of the health coaching parameter in the electronic health record. If the health coaching parameter has an existing value in the electronic health record recording the value of the health coaching parameter is equivalent to updating or modifying the value of the health coaching parameter.

The one or more programs further comprise instructions for selecting a subset of the knowledge used in the response. The response to the at least one question provides a measure of the health coaching parameter. Using the response information or a subset of the knowledge can be selected from the knowledge base which the patient does not understand or know very well. In this way the value of the health coaching parameter is not only determined, but also an information is provided to the patient which can help the patient to better manage his or her therapy. It is useful to have this information immediately after receiving the response, because this aids the patient in recognizing that the response was incorrect and will provide the information necessary to ensure that the patient understands the correct answer or answers to the at least one question.

The one or more programs further comprise instructions for providing the patient with the subset of the knowledge base using the patient user interface. The subset of the knowledge base can be displayed in a variety of ways depending upon the type of content. The patient user interface may have several different types of possible configurations. For instance the patient user interface could comprise a keyboard and a monitor or a keyboard, monitor and a mouse. It could also comprise a touch screen on a handheld device. The computing device and the patient user interface could be integrated into a single unit. There are also embodiments where the health professional user interface and the patient user interface are identical. For instance a nurse visiting a patient could have a handheld computing device with a touch screen. The health professional could request a health coaching parameter using the health professional user interface. The nurse could then either hand the handheld computing device to the patient and the patient could respond or the nurse could orally present questions to the patient and respond for the patient. The patient user interface could also be integrated into a television system. For instance the computing device may connect to a television and generate signals which are usable by the television to present the at least one question and/or also present the subset of the knowledge base. A handheld device could be used by the patient for entering a response into the patient user interface.

In another embodiment the remote patient monitoring system further comprises a diagnostic medical device for periodically measuring a vital sign of the patient. A diagnostic medical device as used herein is a medical device which performs a diagnostic measurement on a patient. A vital sign as used herein is a physical property of a patient which is able to be measured. For instance the weight or blood pressure of a patient may be determined using an appropriate diagnostic medical device. The one or more programs further comprise instructions for initiating the request for a health coaching parameter if the vital sign is outside of a predetermined range. This means that the system monitors a vital sign and if it goes outside of a predetermined range that the patient is provided with at least one question which is used to determine a health coaching parameter. For instance if the blood sugar level of a patient goes outside of a predetermined range it may indicate that the patient is engaging in activities which are detrimental to the treatment of a medical condition or managing a medical condition.

For instance, if the blood sugar is too high it may indicate that a person being treated for diabetes has eaten something containing too much sugar. This may indicate that the diabetic needs to have his or her knowledge checked to determine if an intervention by a health care provider is necessary. This is an aspect which indicates the usefulness of determining a health coaching parameter. For instance in the case of a diabetic eating something sweet, it may indicate that the diabetic does not have enough knowledge about diabetes or it may indicate that the diabetic has a bad attitude about the therapy for managing diabetes. The patient monitoring system can then select a question or questions which are appropriate to determine health coaching parameters which can indicate why the patient's vital sign is out of the predetermined range. Selecting the at least one question using the electronic health record is useful in the situation of the diabetic having a too high blood sugar level. Previous use of the patient monitoring system may have already determined that the patient has sufficient knowledge about how to properly manage diabetes. In this case questions could be used which can be used to test the attitude of the patient towards the management of the diabetic condition.

The diagnostic medical device may have a connection such that the diagnostic medical device communicated the value of the vital sign directly with the patient monitoring system. Alternatively, the value of the vital sign may be input by the patient using the patient user interface.

In another embodiment the one or more programs further comprise instructions for monitoring the value of the vital sign for an interval of time. The template comprises a mapping for adjusting the value of the health coaching parameter based upon a change in the value of the vital sign during the interval of time. This embodiment is advantageous, because a change in the value of the vital sign may indicate that a patient properly understands the medical condition which he or she is being treated for or has a better attitude about the management of the medical condition. The adjustment of the value for the health coaching parameter may also serve as an encouragement for a patient to engage in behavior which is beneficial to the management of the medical condition. Returning to the example of the diabetic, a diabetic may have a health coaching parameter which indicates the patient's attitude towards management of the medical condition. Being aware of this rating may help the patient to refrain from eating foods which contain too many sugars. The same may also be true for other medical conditions such as a patient being overweight. Having a rating which improves with good behavior and decreases with bad behavior may serve as an encouragement.

In another embodiment the one or more programs further comprise instructions for rating the templates based upon the change in the value of the vital sign during the interval time. When a patient incorrectly answers a question, the patient is provided with a subset of the knowledge base based on the incorrect response. If the information provided to the patient was not effective in modifying the patient's behavior, then the system can automatically rate how effective the template was in effecting a change in behavior of the patient. This may be used to modify the questions that are selected for an individual patient and it may also be used in the larger database system to rate the overall efficiency of individual templates for providing information and/or changing the behavior of patients.

In another embodiment the diagnostic medical device is a blood pressure monitor. The blood pressure monitor may be for instance a blood pressure cuff that monitors the blood pressure of the patient.

In another embodiment the diagnostic medical device is a heart rate monitor.

In another embodiment the diagnostic medical device is a scale for monitoring body weight of the patient.

In another embodiment the diagnostic medical device is a blood sugar monitor.

In another embodiment the diagnostic medical device is a thermometer for monitoring body temperature. The thermometer may be able to communicate with the computing device or the patient may input the temperature into the patient user interface.

In another embodiment the diagnostic medical device is a pedometer for monitoring patient activity.

In another embodiment the diagnostic medical device is a body fat analyzer.

In another embodiment the diagnostic medical device is a cholesterol monitor.

In another embodiment the diagnostic medical device is a urine test strip analyzer. A urine test strip analyzer is defined herein as a device which uses urine test strips or other chemical means to analyze urine. For instance a urine test strip analyzer can be used to detect metabolites which are generated by the use of illegal or addictive drugs.

In another embodiment the diagnostic medical device comprises an interface or screen on the patient user interface which is adapted for receiving a numerical pain ranking from the patient. A numerical pain ranking is a numerical value which is assigned by the patient which is used to describe the pain that a patient is currently experiencing. For instance a value of 0 could indicate that the patient experiences no pain and a value of 10 could indicate that the patient experiences excruciating pain which cannot be withstood.

In another embodiment the diagnostic medical device is a breath alcohol device for determining blood alcohol content. The breath alcohol device could be used to monitor consumption of alcohol by an alcoholic.

In another embodiment the diagnostic medical device is a saliva analyzer. The saliva analyzer may be adapted for detecting the use of specific drugs. For instance the detection of illegal or addictive drugs.

In another embodiment the diagnostic medical device is a bioimpedance sensor for determining the level of fluid in the body.

In another embodiment the at least one template form has templates for questions, answers, feedback and a parameter mapping scheme. The questions are the questions that are posed to the patient and for which a response is received from the patient. The answers are the possible responses that would be received via that patient user interface. For instance answers to multiple choice questions could be constructed using the templates. The feedback is a message which informs the patient that a correct answer was received as a response via the patient user interface. Feedback could also be providing the patient with a subset of the knowledge base using the patient user interface. The parameter mapping scheme is the mapping for each of the possible responses to determine a value for the health coaching parameter. The templates have placeholders for data from the domain model. Information from the domain model can be entered into the placeholders and used to construct questions, answers, feedback or a parameter mapping scheme. The templates have placeholders for patient information. Patient information could be the identification number or name of a patient.

In another embodiment the at least one template form is adapted for performing at least one of the following: textual questions, audio questions, video questions, images with questions, avatar based questions, animated questions and multimedia questions.

In another embodiment the domain model is adapted for being updated remotely. The domain model could be stored in memory or in the storage medium of the computing device. Alternatively the domain model could be located on a remote server or computer system which is detected using a network connection.

In another embodiment, the one or more programs further comprise instructions for retrieving the electronic health record from the patient database. The one or more programs further comprise instructions for selecting a template based upon a current value for the health coaching parameter. A current value of the health coaching parameter may be used or information about the patient's current health status or history may be used to select an initial question to determine an initial value for the health coaching parameter.

If a patient has a high level of knowledge of a medical condition it would not make sense to select a question which the patient is already likely to know. In this embodiment questions which are appropriate to the current value of the health coaching parameter are selected so that any change in the health coaching parameter is accurately determined.

In another embodiment the domain model comprises a multimedia database with at least one link to content which is descriptive of the subset of the knowledge base.

In another embodiment the health coaching parameter is a measure of the level of knowledge of the patient about the medical condition.

In another embodiment the health coaching parameter is a measure of the attitude towards attaining a therapy goal.

In another embodiment the health coaching parameter is a measure of progress towards attaining the therapy goal.

In another embodiment the health coaching parameter is a measure of perceived barriers and benefits to achieving the therapy goal.

In another embodiment the health coaching parameter is a measure of a composite measure representing at least two of any of the previously mentioned possible health coaching parameters. For instance the health coaching parameter could be a composite of knowledge about the medical condition and an attitude towards attaining the therapy goal.

In another embodiment the one or more programs further comprise instructions for performing the step of constructing an additional question using the knowledge base, the at least one template form and the response. Instead of immediately providing the patient with the subset of knowledge base an additional question could be posed to the patient. This may be used to further refine the value which should be assigned to the health coaching parameter or to better select the subset of the knowledge base to be provided to the patient which may be used to better trains the patient.

In another aspect the invention provides for a computer-readable storage medium containing instructions that when executed by a computing device of a patient monitoring system cause the computing device to perform a method of determining a health coaching parameter. The computing device comprises at least one processor, memory and storage for the computer-readable storage medium. The patient monitoring system comprises a health professional user interface.

The patient monitoring system further comprises a patient user interface. The patient monitoring system further comprises a patient database comprising an electronic health record belonging to the patient. The patient monitoring system further comprises a domain model comprising a knowledge base for a medical condition. The patient monitoring system further comprises a template database comprising at least one template form for constructing at least one question and possible responses to the at least one question about the medical condition using the domain model.

The at least one template comprises a mapping for each of the possible responses to determine a value for the health coaching parameter. The method comprises receiving a request for a health coaching parameter from the health professional user interface. The method further comprises retrieving the knowledge base for the medical condition. The method further comprises constructing the at least one question and the possible responses using the knowledge base and the at least one template. The method further comprises receiving a response from the patient user interface. The method further comprises determining the value for the health coaching parameter using the response and the mapping. The method further comprises recording the value for the health coaching parameter in the electronic health record of the patient. The method further comprises selecting a subset of the knowledge using the response. The method further comprises providing the patient with the subset of the knowledge base using the patient user interface.

In another aspect the invention provides for a computer implemented method for determining a health coaching parameter of a patient.

In another aspect, the invention provides for a patient coaching method for determining a health coaching parameter of a patient. The method comprises receiving a request for a health coaching parameter. The method further comprises receiving a database for the medical condition from a domain model. The method further comprises constructing at least one question and possible responses to the question using the knowledge base and at least one template form. The at least one template form comprises a mapping for each of the possible responses to determine a value for the health coaching parameter. The method further comprises receiving a response from the patient. The method further comprises determining the value for the health coaching parameter using the response and the mapping. The method further comprises selecting a subset of the knowledge using the response. The method further comprises recording the value for the health coaching parameter in a patient record belonging to the patient. The method further comprises providing the patient with the subset of the knowledge base. This method could be implemented as a computer implemented method or it could be implemented by a person using a computer, paper records or a combination of paper and electronic records.

In the following preferred embodiments of the invention will be described, by way of example only, and with reference to the drawings in which:

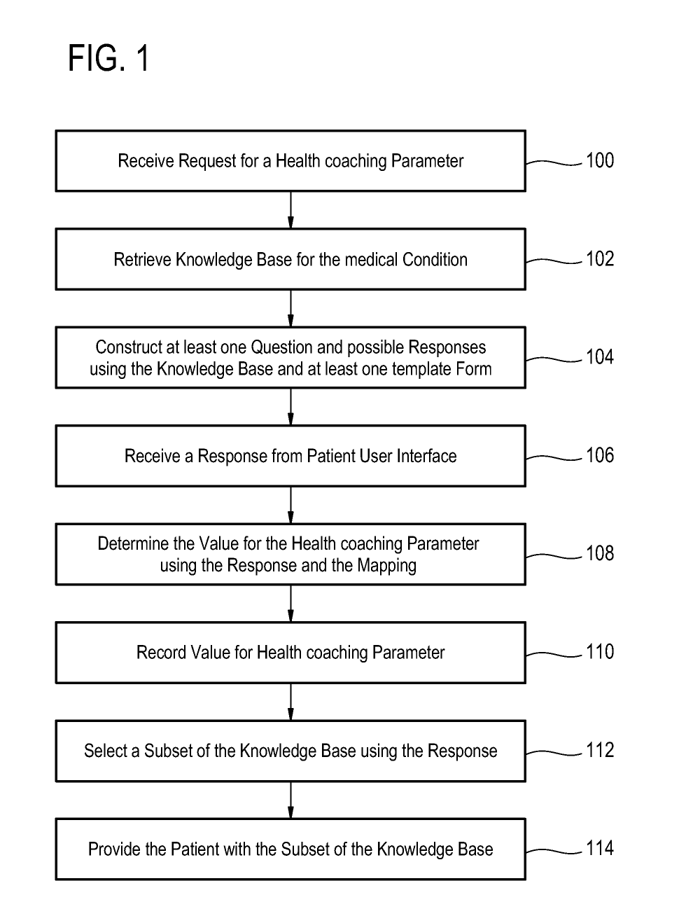

FIG. 1 shows a block diagram illustrating an embodiment of a method according to the invention;

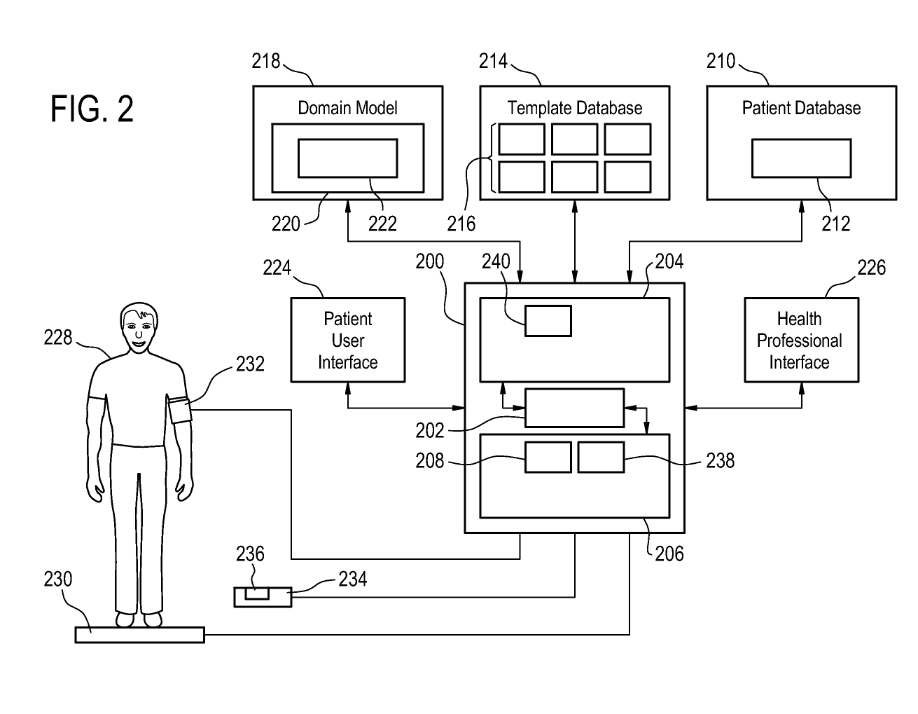

FIG. 2 illustrates a patient monitoring system according to an embodiment of the invention;

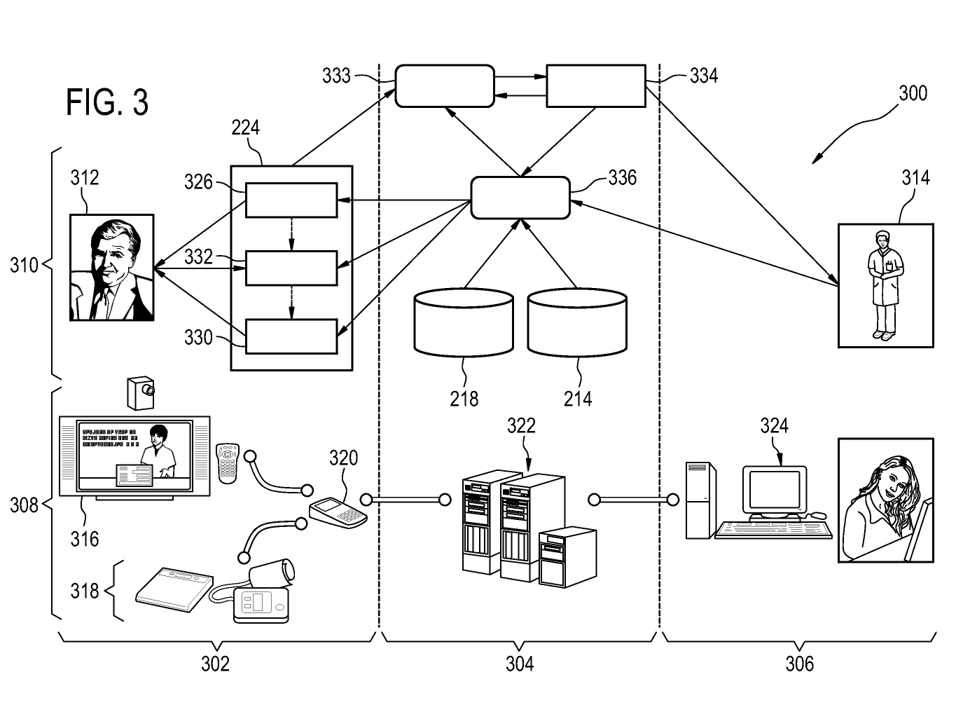

FIG. 3 illustrates a patient monitoring system according to a further embodiment of the invention;

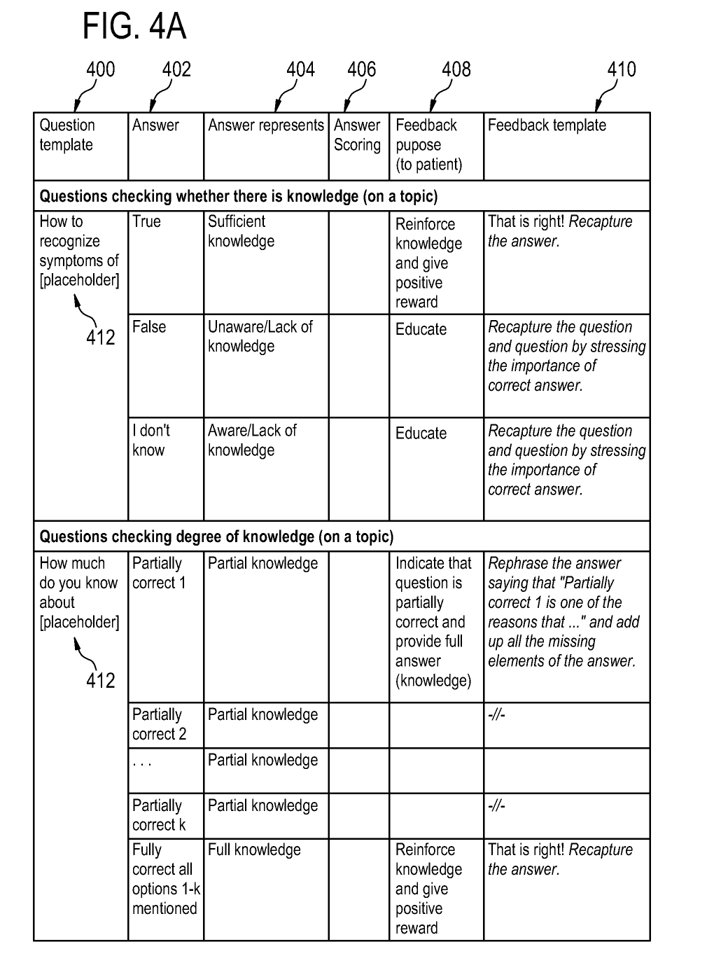

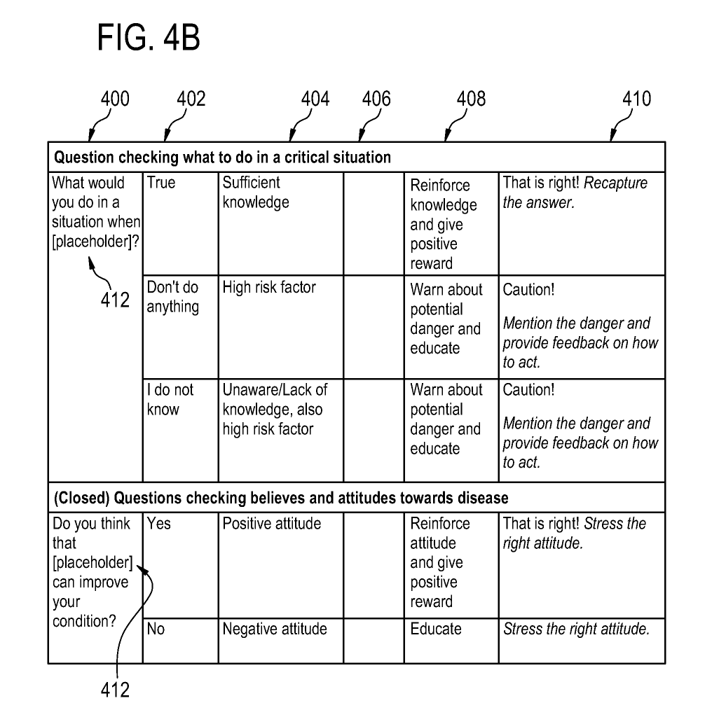

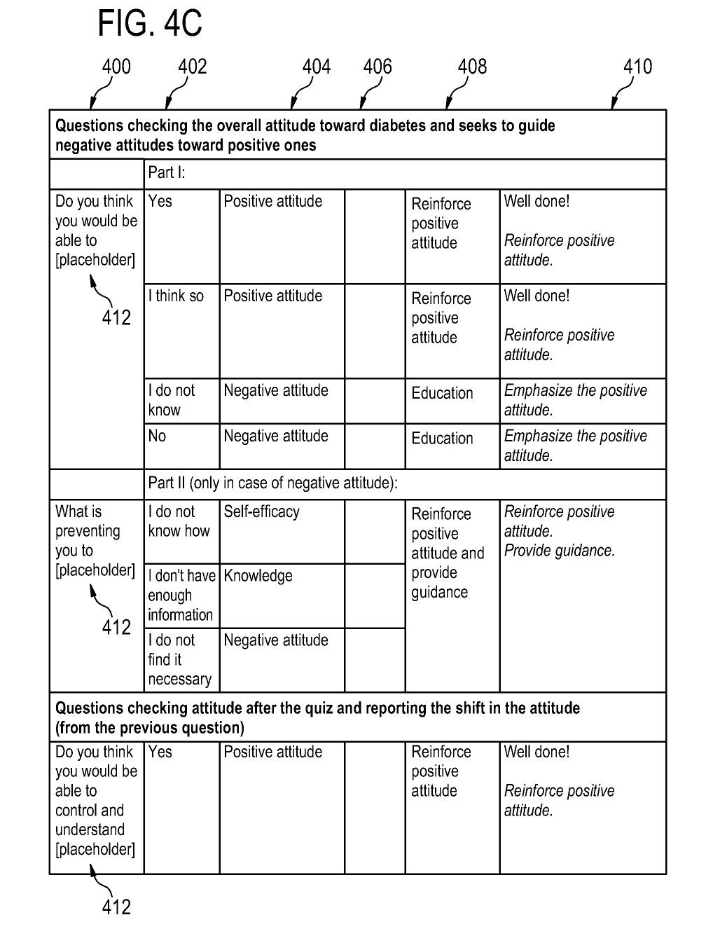

FIG. 4a shows part of a table that illustrates a template form according to an embodiment of the invention;

FIG. 4b shows a continuation of the table illustrated in FIG. 4a;

FIG. 4c shows a continuation of the table illustrated in FIGS. 4a and 4b;

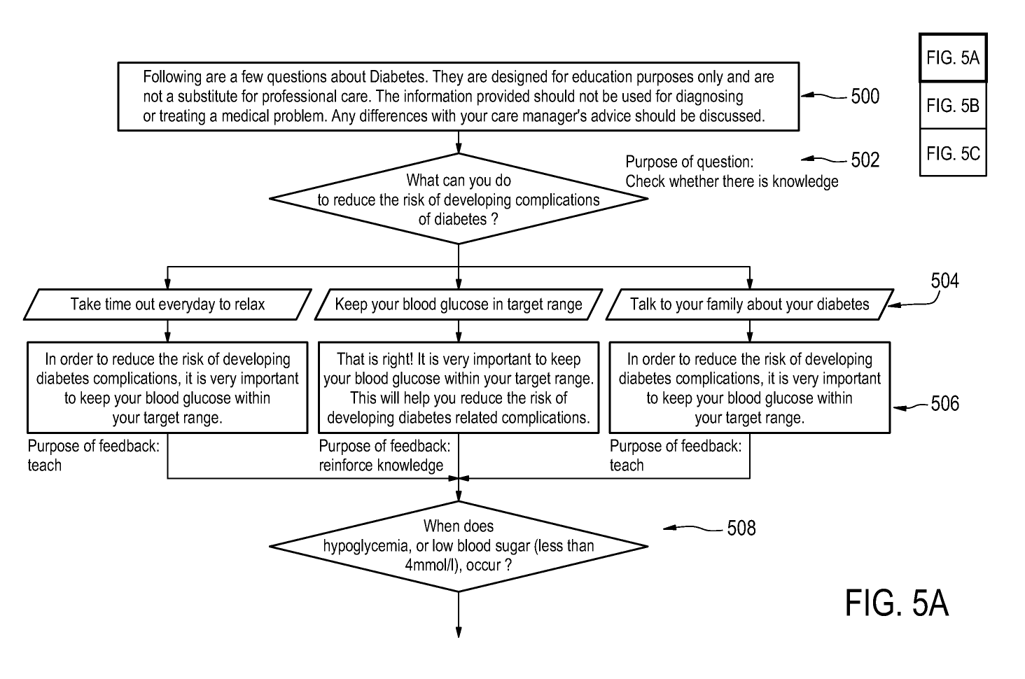

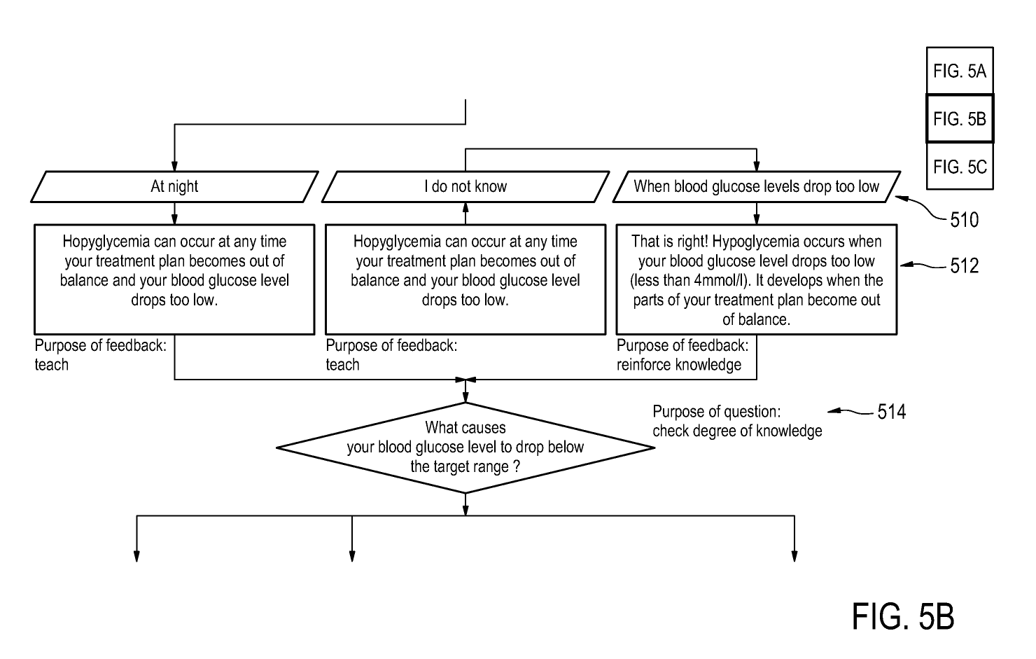

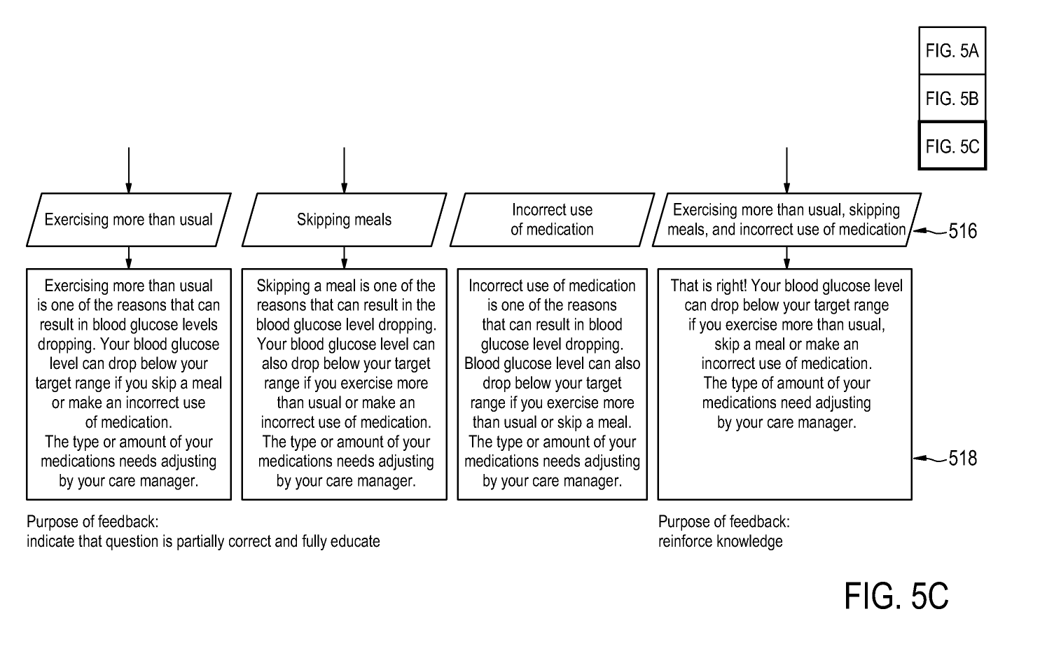

FIG. 5 shows an example of a series of questions, possible answers, and responses posed to a patient in the execution of an embodiment of a method; and

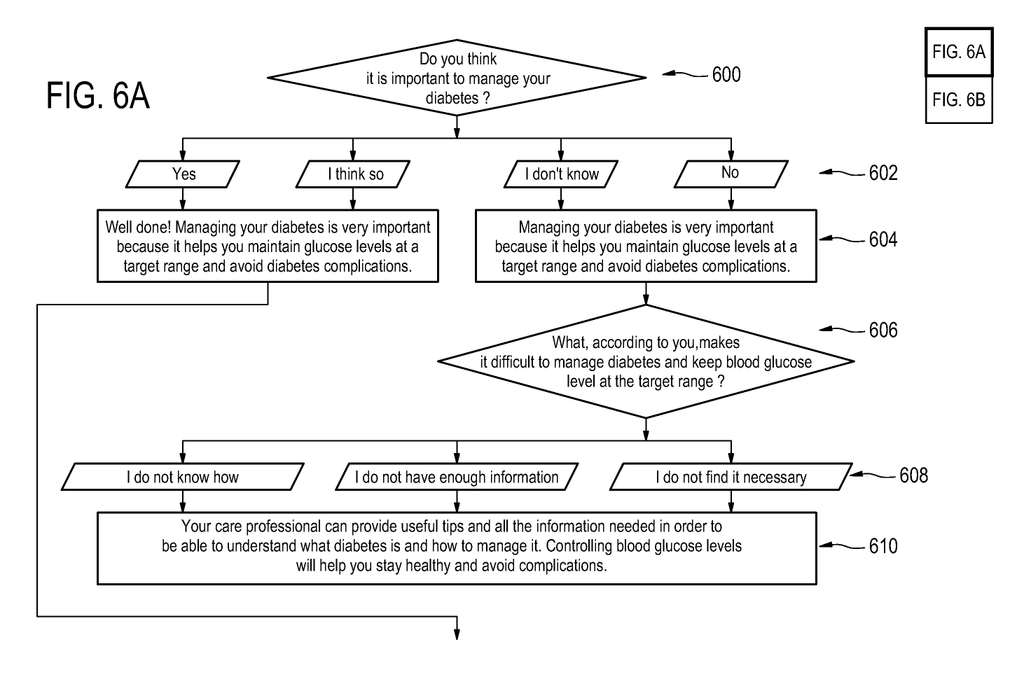

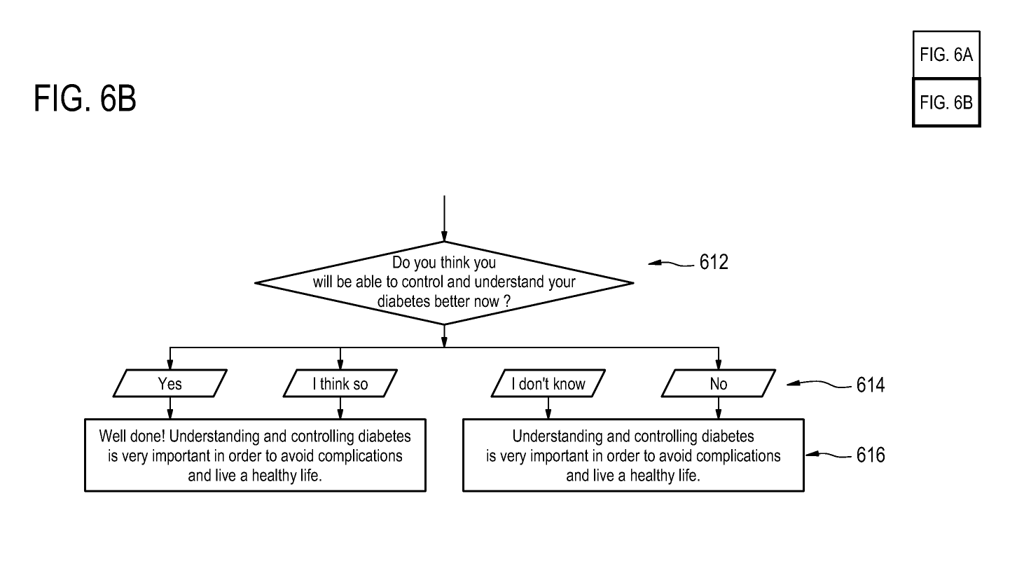

FIG. 6 shows a further example of a series of questions, possible answers, and responses posed to a patient in the execution of an embodiment of a method.

Like numbered elements in these figures are either equivalent elements or perform the same function. Elements which have been discussed previously will not necessarily be discussed in later figures if the function is equivalent.

FIG. 1 shows a block diagram illustrating an embodiment of a method according to the invention. In step 100 a request for a health coaching parameter is received. In step 102 a knowledge base for the medical condition is retrieved. In step 104 at least one question and possible responses to the at least one question are constructed using the knowledge base and at least one template form. The template form may be located in a template database. The template database may be located on a remote server in which case it is retrieved or it may be located locally on a computing device used for performing the method. In step 106 a response from a patient user interface is received. In step 108 a value for the health coaching parameter is determined using the response and the mapping. Then in step 110 the value for the health coaching parameter is recorded. This may be recorded in an electronic health record which belongs to the patient. In step 112 a subset of the knowledge base are selected using the response. In step 114 the patient is provided with the subset of the knowledge base. Providing of the subset of the knowledge base provides training or additional information for the patient.

FIG. 2 illustrates a functional diagram of a patient monitoring system according to an embodiment of the invention. There is a computing device 200. The computing device 200 comprises a processor 202, storage 204, and memory 206. The storage may be any storage which is computer-readable. Examples are, but not limited to: hard disk drives, flash drives and solid state based hard drives. The memory 206 is memory which is directly accessible to the processor 202 for use. The processor 202 may also be multiple processors and the processing tasks may be performed by a single computing device 200 or may be distributed across many computing devices 200 with processors 202. In the computer memory 206 is a program 208. The program 208 is stored in memory 206 and is configured to be executed by the processor 202.

When the program 208 is executed an embodiment of a method according to the invention is executed by the processor 202. The patient monitoring system also comprises a patient database 210 which is connected to the computing device 200. The patient database 210 may be at a remote location for instance as part of a hospital computer system or it may be located within the storage 204 of the computing device 200. The patient database 210 comprises an electronic health record 212 belonging to a patient 228.

The patient monitoring system further comprises a template database 214. The template database 214 comprises template forms 216. The template forms 216 are operable for forming questions and possible response to questions as was described previously. The template database 214 may be located on a remote server or it also may be located locally within storage 204 of the computing device 200.

The patient monitoring system further comprises a domain model 218 comprising a knowledge base 220. When a patient 228 answers a question, the program 208 selects a subset 222 of the knowledge base 220 which is presented to the patient 228 on a patient user interface 224 as a lesson. The patient user interface 224 is connected to the computing device 200. This connection may be a remote connection over a network or the patient interface may be a component of the computing device 200. There is also a health professional interface 226. The health professional interface may also be a component of the computing device 200 or it may be connected to the computing device 200 by a computer network. The health professional interface 226 may be used to inspect the electronic health record 212. The health professional interface may also be used to receive a request for a health coaching parameter from a health professional.

The computer device 200 may also be connected to one or more diagnostic medical devices. The diagnostic medical devices are for periodically measuring a vital sign of the patient. As an example the patient 228 is standing on a scale 230. While using the patient monitoring system the patient 228 may periodically step on the scale 230 to record the weight of the patient 228. In this example the scale 230 is connected directly to the computing device 200. Additionally a blood pressure cuff 232 which uses a blood pressure sensor is also connected to the computing device 200. The patient 228 also periodically monitors his or her blood sugar level using a blood sugar monitor 234. There is a receptacle 236 where the patient 228 places samples of blood.

Located within the memory 206 of the computing device 200 is a vital sign monitoring module 238. This software module 238 is used for monitoring the vital signs using one of the diagnostic medical devices 230, 232, 234. Additionally on the computer storage 204 is a computer-readable storage medium 240 which contains a copy of the program 208. When the contents of the computer-readable storage medium 240 are loaded into the computer memory 208 and are executed by the processor of the computing device the computing device forms a method of determining a health coaching parameter according to an embodiment of the invention.

FIG. 3 illustrates a patient monitoring system that is a remote patient monitoring system 300. The remote patient monitoring system 300 is divided into three layers. There is a patient site 302, a back end 304 and the professional site 306. In this figure, the hardware 308 used by the remote patient monitoring system 300 is shown below a diagram 310 of the software components used by the remote patient monitoring system 300. In the patient site 302 there is a feedback device 316. For this feedback device there is a camera, a television screen and a handheld entry device. A camera may be used to record a patient response to a question or a patient may teleconference with a health care provider 314. The feedback device 316 is connected to an application hosting device 320. The application hosting device 320 is also connected to one or more measuring devices 318. Measuring devices are diagnostic medical devices. The application hosting device 320 is connected to a monitoring and management server 322. The monitoring and management server 322 is also connected to a physician computer system 324 which has clinical applications which are used by a physician 314.

In the patient site 302 the application hosting device 320 and the feedback device 316 are used to implement a patient user interface 224. The patient user interface 224 is able to pose questions 326 to a patient 312. The user interface 224 is also adapted for receiving responses to questions 326. Responses are answers 332 to the questions. Depending upon the response 332 that is received from the patient 312 feedback 330 is provided to the patient 312. The questions 326, answers 332 and feedback 330 are provided by a questionnaire engine 336 which is run by the monitoring and management server 322. The questionnaire engine 336 is a computer program the memory 206 of the monitoring and management server 322. The questionnaire engine 336 interacts with a domain model 218 which provides information or a knowledge base for a medical condition. The questionnaire engine 336 also interacts with a template database 214 which provides template forms for constructing the questions 326, answers 332 and feedback 330. The information in the knowledge base of the domain model 218 is used to fill information into the template form. The questionnaire engine also interacts with the patient electronic health record 334. There is a mapping algorithm 333 which receives the responses 332 from the patient user interface 224. The mapping algorithm 333 is able to modify the health coaching parameter recorded in the electronic health record 334 of the patient 312. The physician 314 is able to examine the patient record 334 on his or her physician computer system 324. In this embodiment the physician computer system 324 functions as the health professional interface. Using the physician computer system 324 a physician 314 is able to send a message to the questionnaire engine 336 which initiates a request for the value of a health coaching parameter.

The system resulting from the essential features of the invention is shown in FIG. 3 is operable for accessing or determining a health coaching parameter by:

1. Question creation by the questionnaire engine 336, and

2. Values of health parameters calculation by the mapping algorithm 333.

The questionnaire creation follows from a request for a health coaching parameter, after which the patient record or profile 334 is retrieved and appropriate template forms are selected. Then the domain model 218 is retrieved and the templates are filled. The output is questions with possible answers and feedback, along with a mapping scheme to be used in the updating of the health parameter in the patient record 334.

The value calculation of the health coaching parameter or updating if its previous value exists is done by the mapping algorithm 333, using the patient's record 334, the results of the questionnaire from the patient, and the mapping scheme, which holds information of how certain answers contribute to a parameter's value.

The patient record or a profile can hold patient data from an electronic health record, the different health and coaching parameters, and a history of questionnaires and results.

Additional features which embodiments of the invention may have are:
The system can be used in a remote patient monitoring system or service, or other (coaching) situations like a face to face consult, implying that all connections in the architecture can involve remote communication means.
The questionnaire templates can include templates for questions, answers, feedback and a parameter mapping scheme. These templates hold placeholders for data from the domain model or patient record such as the patient's name.
The questionnaire templates and questionnaires can be of textual form, audio, video, image, avatar, animation, multimedia, or a combination of these.
The history of questionnaires and results can be used to optionally prevent the same questionnaire (question, feedback, answers) from being presented twice to the same patient.
The feedback can be generated or sent to the patient's device at different times, at generation of time of the questionnaire, or after the patient has answered a question.
The domain models can be medication or disease knowledge bases that are updated automatically by third parties, Philips, the health professional or another service provider.
Specific templates and domain model concepts/relations can be selected based on the previous level of the parameter.
The domain model can include a multimedia database/ontology, linking concepts to content.
The request can also include an interfacing step with the health professional, where the professional sets the purpose of the content/consult, after which the system selects the correct topic or set of topics.
The feedback can also be a request for a new questionnaire, depending on the answer and type of question.

In the embodiment shown in FIG. 3, technical parameters are a set of health coaching parameters that can be added to a patient record, electronic health record, personal health record, or similar data repository of a patient profile. This means that in the patient record the following could be added:

(1) A number of parameters that define:
Level of knowledge of the patient
Current attitude toward attaining a certain goal
Stage in which he is to attain these goals
Perceived barriers and benefits
   (2) Parameter that indicates the overall state of the patient with respect to disease management such as any combination of the above.

These parameters could be linked to a certain condition or therapy. For example, knowledge of heart failure, attitude towards losing weight, stage of change towards anticoagulation management, or the severity of perceived barriers towards taking the medications (i.e., cost of medications). Furthermore, these parameters could be absolute, or relative to a goal set by the care provider.

The parameters can also be divided into sub parameters of which the main parameters are the representation of the total set of sub parameters.

FIG. 3 shows the architecture of the system discussed previously, specified to a disease management situation. This system may be operable to:
Dynamically creates a question or a questionnaire based on a request;
Computes the level of the desired health coaching parameters based on the answers of the patient and making it available to the caring professional; and
Provides feedback to the patient depending on his/her level of health (or coaching) parameters.
   The elements of the system shown in FIG. 3 are:
A repository of question and answer templates.
A repository of feedback templates.
Domain models; Knowledge bases; including disease and drug knowledge bases. Disease knowledge base is made using disease ontology based on guidelines and other data sources, like scientific knowledge of the diseases (physiology, anatomy, etc.). Drug knowledge base contains all knowledge about drugs and their side effects etc. These knowledge bases combined contain up-to-date information about diseases, medications, and guidelines. The knowledge bases are kept updated by third parties, service providers, by Philips, or by the health professionals themselves.
A questionnaire engine that automatically generates the questions, answers and feedback. These are generated based on a request by a health care provider and the patient profile, and optionally a database that holds the information which content, questionnaires and feedback have been provided to this patient (this latter database can be included in the patient profile).
A mapping algorithm that maps the results of the questionnaire to coaching parameter(s) in the patient's profile.
A further optional element is a multimedia database that links concepts in the knowledge base to multimedia instances to be used, instead of text based filling of questionnaires, this can be a part of the domain model.

The question template repository consists of questions templates, answers templates, feedback templates, and scoring schemes. The scoring algorithm may generates the score with the answers.

The questionnaires should support the filling of the newly defined patient record parameters. In order to do this correctly and reliable, each question must have a purpose. So now we define a set of questions in a question repository, database, and collection or similar, along with meta-information, a field, etcetera, that describes to which parameter in the patient record the question is linked.

For example, the questions:

“What does it mean if my weight increases rapidly?” is a question that relates to the parameter knowledge of heart failure, while the question
“Do you think about the costs of your medications when you plan on doing large purchases?” links to perceived barriers towards taking medications.

Hence, the repository contains a number of pre-defined question templates, which are questions that include placeholders for (medical) expressions, words, ontologies, concepts, images, multimedia content. The question template can be annotated with a question type and purpose. The purpose refers to a health parameter, while the type refers to the structure of the question and answers. The type is used for the scoring algorithm and to determine feedback.

The types of the questions could be:

(1) Questions checking whether there is knowledge (on a topic)
(2) Questions checking the depth of the knowledge (on a topic)
(3) Questions checking how to respond in a critical situation (about the topic)
(4) Questions checking specific attitudes and believes (on a topic)
(5) Questions checking overall attitude and believes toward diabetes
(6) Questions targeting to guide negative attitudes toward positive ones (in case of detecting negative attitude)
(7) Questions checking the effect on the attitudes after the quiz

FIGS. 4a, 4b and 4c are part of a single table which illustrates the construction of a template form which could reside in a template database. In table 4a, 4b and 4c there are different columns. In column 400 there is a question template. With the question templates 400 there are questions with a placeholder 412. The placeholder in these questions can be replaced with specific medical conditions or descriptions of terms about the particular medical condition. In column 402 are possible answers to the question in the question column 400. In column 404 is a mapping or what the answer represents. The information in 404 is used to determine the health coaching parameter and represents a mapping. The column 406 is a blank space left for answer scoring. A method could be performed by a computer or it could be performed by a person. If performed by a person the answer could be scored in column 406. In column 408 there is a column which represents the purpose of feedback which is provided to the patient. In column 410 there is an example of textual feedback that is provided to the patient after giving a particular answer 402.

Examples of different types of questions are the “do you know” question, the “how much do you know question”, or a “likert scale” question, as illustrated in Table 4.

Answers are directly related to the questions being asked. Depending of the purpose of the questions the answers have specific structure. As an example, we take the question that addresses the knowledge of heart failure with corresponding answers:

“What does it mean if my weight increases rapidly?”
a. This means there is a fluid build-up in my body
b. I don't know
c. I ate too much fatty food the day before

The answers must now resemble the change in value of the parameter. There could be a direct link between the value of the parameters and the answers, or there can be a transition algorithm, such that the answer determines the change of value, or there can be a link towards a second or multiple other parameter, where an answer determines the difference between another parameter. The scoring algorithms can optionally also take information from the patient record, like the current score for a health parameter, or other information like age.

Answer a is the correct answer and should add positively to the knowledge of heart failure parameter, answer b is a neutral answer, but does reveal there is a knowledge gap, answer c is wrong, which is more severe than not knowing. A score to the answers discussed in the last paragraph could for example be: +1, −1, −2 towards the knowledge parameter.

FIG. 5 shows an example of a series of questions posed to a patient in the execution of an embodiment of a method according to the invention. Initially in step 500 a disclaimer is displayed on the patient user interface. There is a first question 502 posed to the patient. The three boxes labeled 504 show possible responses which are presented to the patient. The patient then selects one of these possible answers to the question 502. Depending upon which answer 504 is selected a response 506 is displayed. A second question 508 is then asked. In the second question three possible answers 510 are also provided to the patient. Below the possible answers 510 are possible feedback or training 512 which is provided to the patient 228. Feedback in the examples in FIG. 5 is providing the subset of the knowledge base based on the response. Next a third question 514 is asked. For this question 514 there are four possible answers 516 which are provided to the patient. Below the four possible answers 516 are feedback 518 which are used to either reinforce the patient or provide information and instruction about the patient's medical condition.

FIG. 6 shows an example of the questions and responses presented to a subject during an execution of a method according to the invention. In this example the feedback is a second question. In the example of FIG. 6 initially the patient is presented with a first question 600. There are four possible responses 602 which are presented to the patient at the same time the question 600 is presented to the patient. There are two possible responses 604 and these responses correspond to the questions 602 above them. There is a second question 606 which corresponds to when the patient does not know very much about diabetes according to the response to the first question 600. The second question 606 forms a response to question 600. There are three possible responses to the question 606. After the patient selects one of the three questions 608 there is a response 610 which provides additional information on the importance of properly managing blood glucose levels. When the patient gave a response which indicated more knowledge about properly managing diabetes a third question 612 was asked instead of question 606. There are four responses 614 to question 612. There are two feedbacks 616 to the four possible answers 614. The third question 612 tests the patient's knowledge further and then provides these two responses 616 depending upon the further knowledge level of the patient.

A questionnaire is used to assess the patient, but also to give the patient direct feedback on his or her answer and thereby address the appropriate health coaching parameter. This way the patient can be educated. The feedback is coupled directly to the question and the answer, and the questionnaire engine can tailor feedback to the patient, using information from the patient record about current value of the health coaching parameter(s) under assessment. Furthermore there can be a database that holds information which feedback the patient received, optionally letting the questionnaire engine generate different feedback. See also FIG. 5 for a resulting tree of questionnaires. FIG. 6 shows a tree that results from feedback, where the feedback sends a request to the questionnaire engine itself.

To do this reliably and generically, we define a feedback repository that hold feedback templates. Feedback templates are also shown in the table shown in FIG. 4a through 4c.

The questionnaire engine may take as input:
Request (for example for the assessment of a specific coaching/health parameter by the care professional);
Repositories of questions, answers, and feedback;
Disease knowledge bases, drug knowledge bases, etc.
Patient profile;
(Optional) Database of previously presented questions/feedback;
(Optional) multimedia database; and
   produces as output a question with set of answers and belonging feedback messages.

The engine may achieve this using the following algorithmic steps:
Take the request and based on it decide on the question
Fill the [placeholder] in the questions using information from knowledge bases. The questionnaire engine knows which question template to select, and which sources for the placeholders to use, with input from the “request” that initializes the question generation, and the patient status, in the patient record. (based on request, random selection, and/or purpose)
Fill in appropriate answers
Generate feedback

A mapping algorithm is used to update the result of a patient's answer to a question in the health record correctly, we define a scoring/transition step, that analyses the type of question, the answer, the parameter, topic, and optionally other information, like therapy plan to come to a correct update of the mental state parameter.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

### LIST OF REFERENCE NUMERALS

200 Computing device
202 Processor
204 Storage
206 Memory
208 Program
210 Patient database
212 Electronic health record
214 Template database
216 Template forms
218 Domain model
220 Knowledge base for a medical condition
222 Subset of the knowledge base
224 Patient user interface
226 Health professional interface
228 Patient
230 Scale
232 Blood pressure sensor
234 Blood sugar monitor
236 Rceceptical for blood
238 Vital sign monitoring module
240 Computer-readable storage medium
300 Remote patient monitoring system
302 Patient site
304 Back-end
306 Professional site
308 Hardware
310 Functional diagram of program components
312 Patient
314 Health care provider
316 Feedback device
318 Measuring device
320 Application hosting device
322 Monitoring and management server
324 Physican computer system with clinical applications
326 Questions
328 Possible answers
330 Feeback
332 Answer
333 Mapping algorithm
334 Electronic health record
336 Questionare engine

1. A patient monitoring system for determining a health coaching parameter of a patient, the patient monitoring system comprising:
a template database comprising template forms for constructing questions and possible responses about medical conditions, wherein individual template forms comprise a mapping for individual ones of the possible responses to determine a value for the health coaching parameter;
a computing device comprising: at least one processor, memory, and one or more programs; wherein the one or more programs are stored in memory and configured to be executed by the one or more processors; wherein the one or more programs comprise instructions for:
receiving a request of a user for a determination of an updated value of a health coaching parameter, wherein the request includes an identifier associated with an electronic health record corresponding to the patient;
retrieving the electronic health record associated with the patient, wherein the electronic health record indicates a current value for the health coaching parameter;
retrieving information from a knowledge base based on a medical condition;
selecting at least one template form from the template database, wherein the selection is based on the current value for the health coaching parameter;
constructing at least one question and the possible responses using the information from the knowledge base and the at least one template form;
providing the at least one question to the patient;
receiving a response of the patient to the at least one question;
determining the updated value for the health coaching parameter based on the received response and the mapping;
recording the updated value of the health coaching parameter in the electronic health record;
selecting a subset of the information from the knowledge base, wherein the selection is based on the received response; and
providing the patient with the selected subset of the information from the knowledge base.

2. The patient monitoring system of claim 1, wherein the remote patent monitoring system further comprises a diagnostic medical device for periodically measuring a vital sign of the patient; and wherein the one or more programs further comprises instructions for initiating the request for the determination of the updated value of the health coaching parameter if the vital sign is outside of a predetermined range.

3. The patient monitoring system of claim 2, wherein the one or more programs further comprises instructions for monitoring the value of the vital sign for an interval of time, wherein the determination of the updated value for the health coaching parameter is further based upon a change in the value of the vital sign during the interval of time.

4. The patient monitoring system of claim 3, wherein the one or more programs further comprises instructions for rating the template forms based upon the change in the value of the vital sign during the interval of time.

5. The patient monitoring system of claim 2, wherein the diagnostic medical device is any one of the following: a blood pressure monitor, a heart rate monitor, a scale for monitoring body weight, blood sugar monitor, a thermometer for monitoring body weight, a pedometer for monitoring patient activity, a body fat analyzer, a cholesterol monitor, a urine test strip analyzer, an interface adapted for receiving a numerical pain ranking from the patient, saliva analyzer, bioimpedance sensor, and a breath alcohol device for determining blood alcohol content.

6. The patient monitoring system of claim 1, wherein the at least one template form has templates for questions, answers, feedback and a parameter mapping scheme; wherein the template forms have place holders for information from the knowledge base; and wherein the template forms have place holders for patient information that is included in the electronic health record corresponding to the patient.

7. The patient monitoring system of claim 1, wherein the at least one template form is adapted for forming at least one of the following: textual questions, audio questions, video questions, images with questions, an avatar based questions, animated questions, and multimedia questions.

8. The patient monitoring system of claim 1, wherein the knowledge base is adapted for being updated remotely.

9. The patient monitoring system of claim 2, wherein the selection of the at least one template form is further based on a change in the value of the vital sign during the interval of time.

10. The patient monitoring system of claim 1, wherein the electronic health record further indicates a medical condition, and wherein the knowledge base comprises a multimedia database with at least one link to content which pertains to the medical condition.

11. The patient monitoring system of claim 1, wherein the health coaching parameter is a measure of any one of the following: level of knowledge of the patient about the medical condition, attitude towards attaining a therapy goal, progress towards attaining the therapy goal, perceived barriers and benefits to achieving the therapy goal, and a composite measure representing at least two of the preceding items.

12. The patient monitoring system of claim 1, wherein the one or more programs further comprise instructions for performing the steps of selecting an additional template form based on the response, and constructing an additional question using the information from the knowledge base and the additional template form.

13. The patient monitoring system of claim 1, wherein the one or more programs further comprise instructions for retrieving the selected template form from the template database.

14. The patient monitoring system of claim 1, wherein providing the at least one question to the patient is accomplished through a patient user interface.

15. A computer-readable storage medium containing instructions that when executed by a computing device of a patient monitoring system cause the computing device to perform a method of determining a health coaching parameter of a patient; wherein the computing device comprises at least one processor for executing the instructions; wherein the patient monitoring system further comprises a template database comprising at least one template form for constructing at least one question and possible responses about medical conditions, wherein individual template forms comprise a mapping for individual ones of the possible responses to determine a value for the health coaching parameter; the method comprising:
receiving a request for a determination of an updated value of a health coaching parameter from a health professional, wherein the request includes an identifier that identifies an electronic health record corresponding to the patient;
retrieving the electronic health record that corresponds to the patient, wherein the electronic health record includes a current value for the health coaching parameter;
retrieving information from a knowledge base based on a medical condition;
selecting at least one template form from the template database, wherein the selection is based on the medical condition and on the current value for the health coaching parameter;
constructing at least one question and the possible responses using the information from the knowledge base and the at least one template form;
providing the at least one question to the patient;
receiving a response from the patient;
determining the updated value for the health coaching parameter based on the received response and the mapping;
recording the updated value of the health coaching parameter in the electronic health record;
selecting a subset of the information in the knowledge base, wherein the selection is based on the received response; and
providing the patient with the selected subset of the information from the knowledge base.

16. A patient coaching method for determining a health coaching parameter of a patient, the method comprising:
receiving a request for a determination of an updated value of a health coaching parameter, wherein the request includes an identifier that identifies an electronic health record corresponding to the patient;
retrieving the electronic health record that corresponds to the patient, wherein the electronic health record includes a current value for the health coaching parameter;
retrieving information from a knowledge base based on a medical condition;
selecting at least one template form from a template database, wherein the selection is based on the medical condition and on the current value for the health coaching parameter;
constructing at least one question and possible responses using the information from the knowledge base and at least one template form, wherein the at least one template form comprises a mapping for individual ones of the possible responses to determine an updated value for the health coaching parameter;
providing the at least one question to the patient;
receiving a response from the patient;
determining the updated value of the health coaching parameter based on the response and the mapping;
recording the updated value of the health coaching parameter in the electronic health record corresponding to the patient;
selecting a subset of the information from the knowledge base, wherein the selection is based on the received response; and
providing the patient with the selected subset of the information from the knowledge base.
